(19) United States
(12) Patent Application Publication
(10) Pub. No.: US 2024/0419965 A1
(43) Pub. Date: Dec. 19, 2024

(54) SYSTEMS AND METHODS OF TRAINING NEURAL NETWORKS USING MACHINE LEARNING

(71) Applicant: NASDAQ, INC., New York, NY (US)

(72) Inventors: Josep PUIG RUIZ, Boston, MA (US); Cole WITASZEK, Brooklyn, NY (US); Yongheng ZHANG, Chelsea, MA (US)

(21) Appl. No.: 18/737,850

(22) Filed: Jun. 7, 2024

Related U.S. Application Data
(60) Provisional application No. 63/507,896, filed on Jun. 13, 2023.

(51) Int. Cl. G06N 3/08

(52) U.S. Cl. CPC G06N 3/08

(57) ABSTRACT

A system that trains a neural network to generate an embedding is provided. The system uses the trained neural network to then train additional task models from the generated embeddings. The resulting trained models may then be deployed to distributed processing systems that accept and process data transaction requests. The models are used to provide predictions using the current state of a data structure, which is being continually modified based on newly received data transaction requests.

### CROSS REFERENCE(S) TO RELATED APPLICATION(S)

This application claims priority to U.S. provisional application No. 63/507,896, filed Jun. 13, 2023, the entire contents being hereby incorporated by reference.

### TECHNICAL OVERVIEW

The technology described herein relates to machine learning, training neural networks, and distributed systems that use trained models to generate output signals. More specifically, the technology described herein relates to training neural networks to generate embeddings of an input data structure; the embeddings are then used in further neural networks to produce output signals.

### INTRODUCTION

Modern society generates vast amounts of diverse data and making predictions on this data—from weather data (e.g., temperature), to traffic data (e.g., a volume of cars on a given road), to service call data (e.g., a number of calls received), to electrical production/consumption data (e.g., kilowatt-hours), to many other forms of data—can result in valuable improvements.

One way to make such predictions is using machine learning techniques in order to train computers about a task without expressly programming the computer for that task. This may be accomplished by developing a model (e.g., a mathematical model) based on initial data and then using that model to assess new data (e.g., to make a prediction). For example, a model may be developed to automatically recognize and distinguish between photos that contain dogs and photos that contain cats. The model can then be used to form a prediction as to whether a given photo contains a cat or a dog. Other examples of using machine learning to make predictions can include weather predictions based on current metrological factors, making a prediction of travel time based on current traffic conditions, making predictions in allocation of computing resources, and other technical areas in which predictions may be advantageously used.

However, making predictions can be technically difficult as some types of data do not lend themselves to being analyzed so easily. Accordingly, it will be appreciated that new and improved techniques, systems, and processes are continually sought after—especially in the area of machine learning and generating models that can make predictions on complex data structures.

### SUMMARY

A computer system is provided for training a neural network to generate embeddings for a data structure. In some examples, the data structure may represent a state of a data structure as that data structure evolves over time. The embeddings produced by the trained neural network are then used to train additional neural networks to make predictions based on the data structure. Multiple different neural networks may be trained based on the same embedding. The generated embedding can be used to facilitate quicker training for multiple downstream tasks such as, for example, prediction of two different outputs that have related underlying predictor variables.

In some examples, a trained neural network is provided that takes a snapshot of a data structure at a given point in time and generates an embedding of that snapshot with a trained neural network. The generated embedding is then used against multiple different neural networks to generate multiple different output signals (e.g., predictions) regarding the state of the snapshot of the data structure. The predictions may be communicated to client systems, which may then use those predictions for further processing.

This Summary is provided to introduce a selection of concepts that are further described below in the Detailed Description. This Summary is intended neither to identify key features or essential features of the claimed subject matter, nor to be used to limit the scope of the claimed subject matter; rather, this Summary is intended to provide an overview of the subject matter described in this document. Accordingly, it will be appreciated that the above-described features are merely examples, and that other features, aspects, and advantages of the subject matter described herein will become apparent from the following Detailed Description, Figures, and Claims.

### BRIEF DESCRIPTION OF THE DRAWINGS

These and other features and advantages will be better and more completely understood by referring to the following detailed description of example non-limiting illustrative embodiments in conjunction with the drawings of which:

FIG. 1 is an architecture diagram that shows an example computer system according to certain example embodiments;

FIG. 2 is a flow chart of an example machine learning training process that may be performed by the computer system shown in FIG. 1 according to certain example embodiments;

FIG. 3 graphically illustrates the training techniques used by the example machine learning training process of FIG. 2 according to certain example embodiments;

FIG. 4 is a graphical representation of an example neural network produced using the machine learning training process of FIG. 2 to generate embeddings for an example data structure according to certain example embodiments;

FIGS. 5A-5B are example neural networks trained to use the embeddings that are produced by the neural network of FIG. 4 according to certain example embodiments;

FIG. 6 illustrates a data structure that is generated using data messages according to certain example embodiments;

FIG. 7 illustrates how the data structure that is generated as shown in FIG. 6 can be reduced in dimensionality according to certain example embodiments;

FIG. 8 is an architecture diagram that shows an example computer system that uses the trained model(s) generated by the system of FIG. 1 according to certain example embodiments;

FIG. 9 is a flow chart of a process that may be implemented on the computer system of FIG. 8 to generate output data from trained machine learned models that is then delivered to client systems according to certain example embodiments;

FIG. 10 is an example of the data that can be generated when the computer system of FIG. 8 uses a trained model and the process of FIG. 9 according to certain example embodiments; and

FIG. 11 shows an example computing device that may be used in some embodiments to implement features described herein.

### DETAILED DESCRIPTION

In the following description, for purposes of explanation and non-limitation, specific details are set forth, such as particular nodes, functional entities, techniques, protocols, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail.

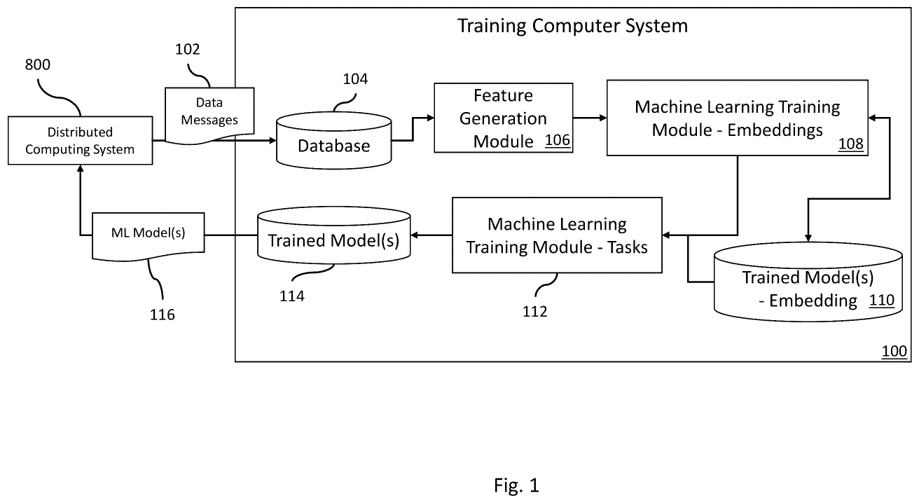

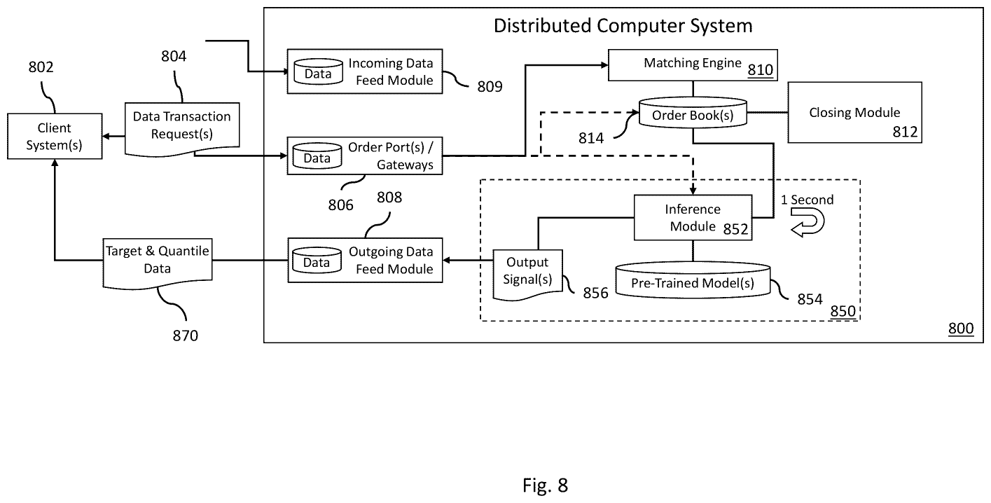

Sections are used in this Detailed Description solely in order to orient the reader as to the general subject matter of each section; as will be seen below, the description of many features spans multiple sections, and headings should not be read as affecting the meaning of the description included in any section. Some reference numbers are reused across multiple Figures to refer to the same element; for example, as will be provided below, the Distributed Computer System 800 that is shown in FIG. 1 is also referenced and described in connection FIG. 8.

### Overview And Technical Advantages

In certain examples, a system is provided that trains a model to generate an embedding (e.g., an E-dimensional vector, where E is the number of dimensions that the vector represents) of a view of a data structure. As used herein, terms such as view, snapshot, state, representation, and the like may be used to describe the data structure at a given point in time—e.g., during processing by a distributed computer system. Thus, for example, the data structure can be thought of having different states for which the transitions between those states are managed or carried out by the processing data transaction requests that have been submitted to the distributed computer system for processing. Due to the size of the embedding (e.g., 100s of dimensions) it is at least impractical to process such data in a manual setting. The approach of using an embedding to represent a data structure (e.g., a dual-sided data structure) is a technical improvement over other approaches as the number of dimensions represented within the embedding allows for greater fidelity in providing an understanding to machine learning processing regarding the state of the data structure. The approach allows for training ML models that are more predictive than prior approaches.

The data structure can represent the state of physical elements (e.g., the weather, the allocation of containers in shipping or rail, traffic of cars or trains, or the like), the state of data within a computing environment (e.g., the scheduling of computer processes, allocation of processing resources for requested tasks, or the like), or a combination thereof.

The training process includes first generating a fixed size input data structure that is based on the data structure. We define an auxiliary task that encourages the model to understand the high-level structure of the data. An example of this is predicting the order of two consecutive sentences which may have been swapped or may be in the original order. In a regression context, an in connection with the examples described herein, it can be helpful to take a regression target for a prediction and generate quasi-class labels by breaking the true label into buckets and first training on the generated quasi-class. Accordingly, in some examples, class labels can be automatically assigned to each snapshot. The assignment of labels for a given sample can be based, for example, on how far an equilibrium value for that sample is from the value that was determined for that data structure. For example, if a data structure includes records for multiple temperature sensor readings, then the equilibrium value may be the average temperature (or midpoint) of all the temperature readings and the final value may be the actual temperature value at some future point in time. For example, the class labels may be associated with different temperature ranges in relation to the equilibrium temperature value. The label assigned to the given sample may be based on which range the sample falls into. For example, if the equilibrium value for a given sample was −0.5% off of the final temperature value, then that sample may be placed into the 0.0%-−1.0% temperature range class. Other samples may be assigned accordingly. This approach of automatically assigning class labels advantageously facilitates the process of training the neural network as the class labels do not need to be manually assigned.

By targeting the model to perform well in a task that requires understanding the general structure of the data, the model will tend to learn an improved lower dimensional representation of that data for the embedding vector (e.g., the vector prior to an output layer for an auxiliary task). This approach allows, for example, information represented in the data that has been compressed into a single row to be retained (e.g., at least partly) for the training of the neural network. Once trained, the weights of this neural network (called an “embedding model” herein) are frozen.

Embeddings generated by the embedding model can then be used to train multiple different models for different tasks (each being called a “task model” herein-a first take model, a second task model, etc.). Machine learning techniques such as regression and classification may be used in certain example embodiments to generate the task models using the generated embeddings. Such task models may be neural networks or other types of ML models. This technique of using the embeddings to train these task models is a technical improvement over other approaches as the way in which the embeddings are generated provides a more machine understandable form that can be used to train the task models. It thereby allows more machine learned models to be generated for additional specific tasks. More specifically, the training time for such tasks may be relatively decreased with an approach that uses embeddings as opposed to one that does not. This is facilitated, at least in part, by reusing a single trained embedding for different task models.

The trained task and embedding models may be deployed to a distributed computing system that processes data transaction requests. The models generate predictions (e.g., one or more predictive values) given a snapshot of a data structure for a given time. The predictions may be communicated to third parties. The approach of using trained models (e.g., neural network(s)) in this manner provides for a technical improvement where the results of the predictive values are more predictive of the future/final determined value(s) than prior approaches. In some instances, the predictions are more stable (e.g., do not change as much from one prediction to another—for example, predictions that are in in time series may have lower variance from second to second); more predictive (e.g., a better indicator of the final value throughout the time period in which data transaction requests are accepted); and/or more consistent (e.g., the results of using the training models described herein hold for the vast majority use cases).

In the examples disclosed herein, the data structure is an order book that is maintained by an electronic trading platform. However, the disclosure is not so limited, and it will be appreciated that the methods and systems disclosed herein can be applied to many other types of data structure, for example data structures for weather data, traffic data, service call data, electrical production/consumption data, allocation of computing resources (e.g., in a cloud-based computing environment), and the like.

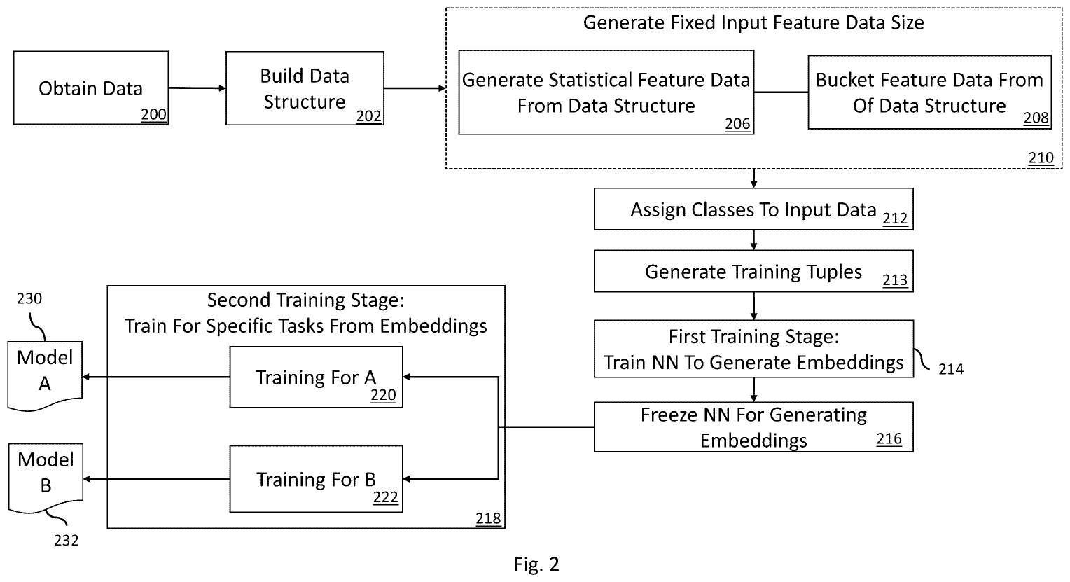

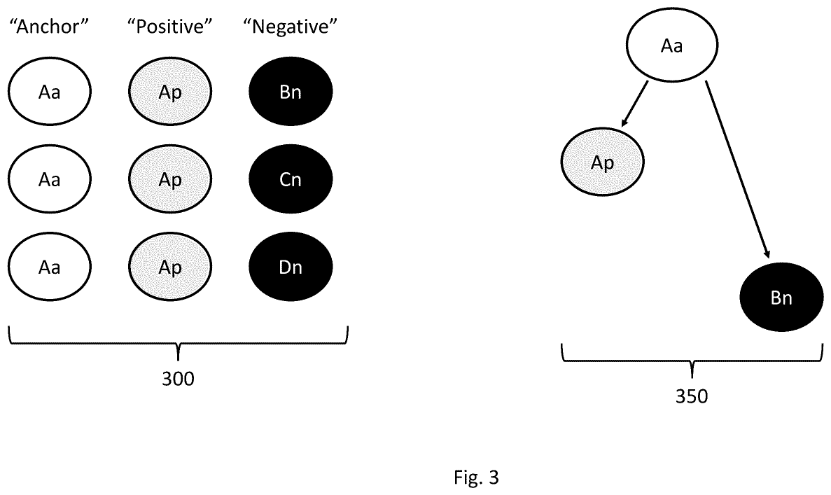

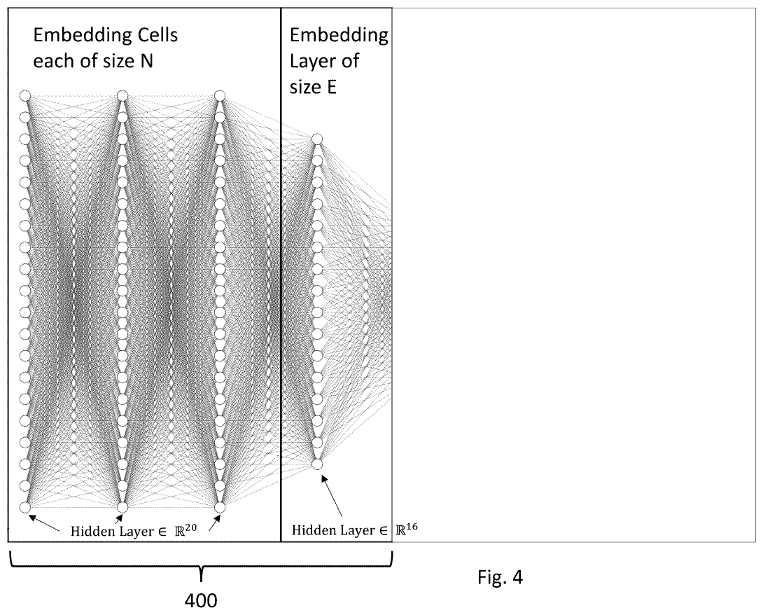

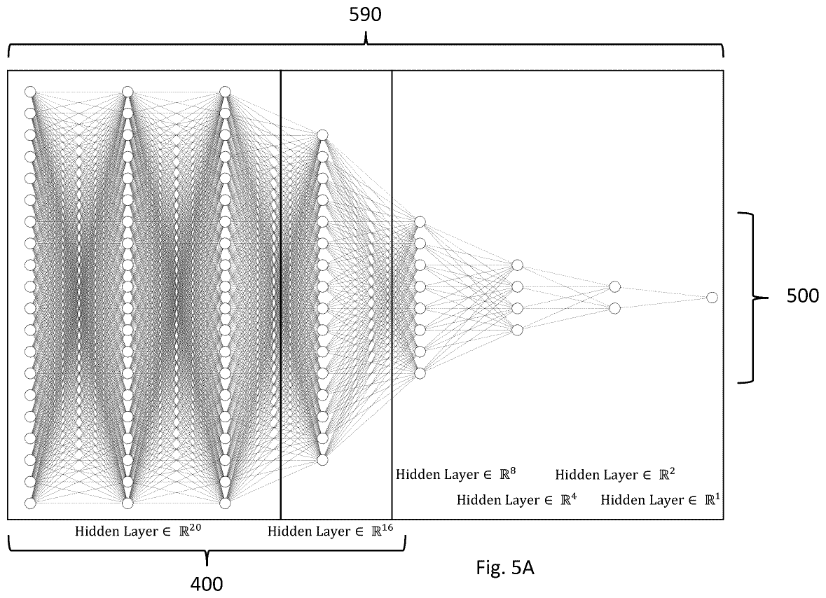

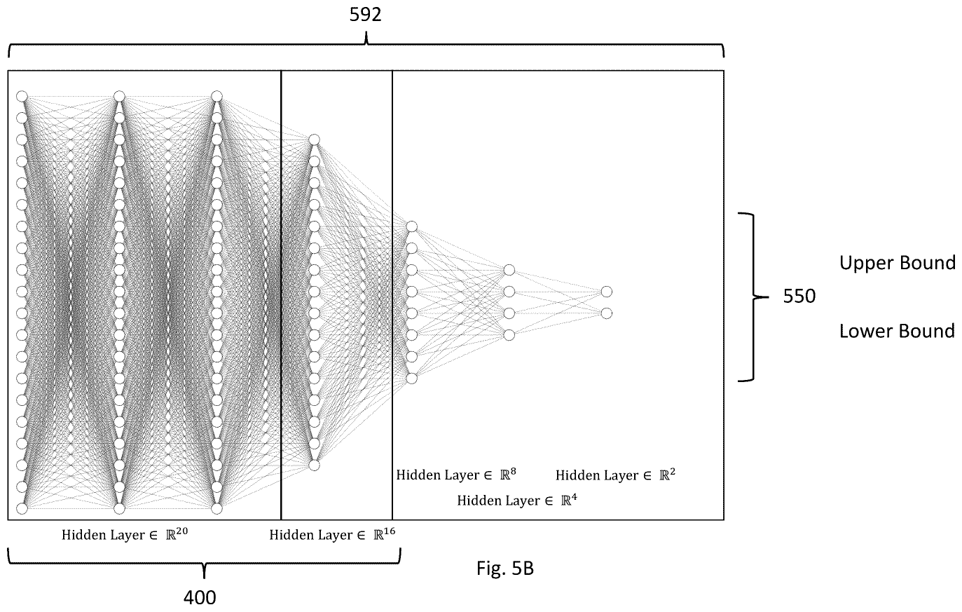

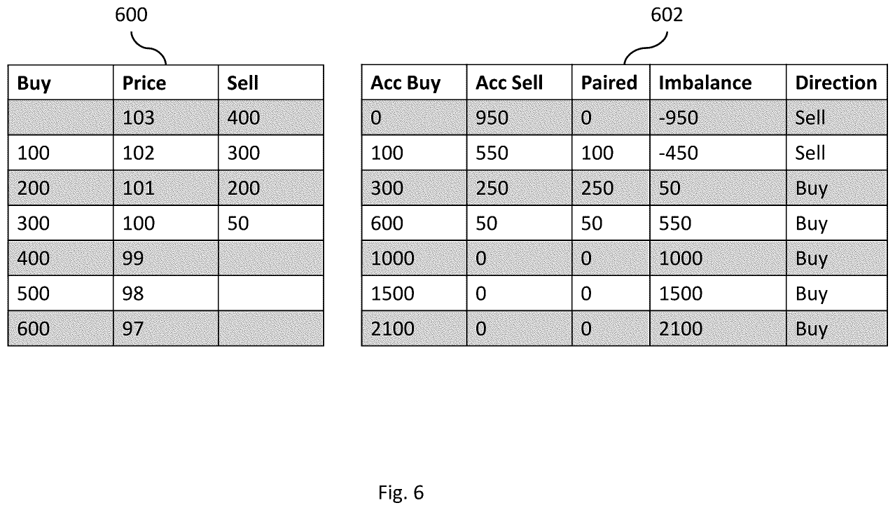

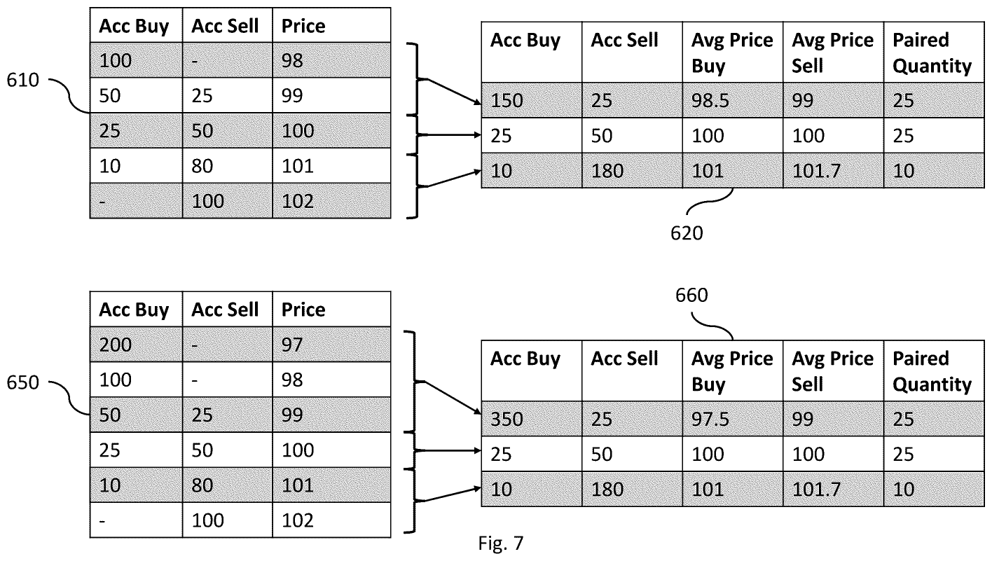

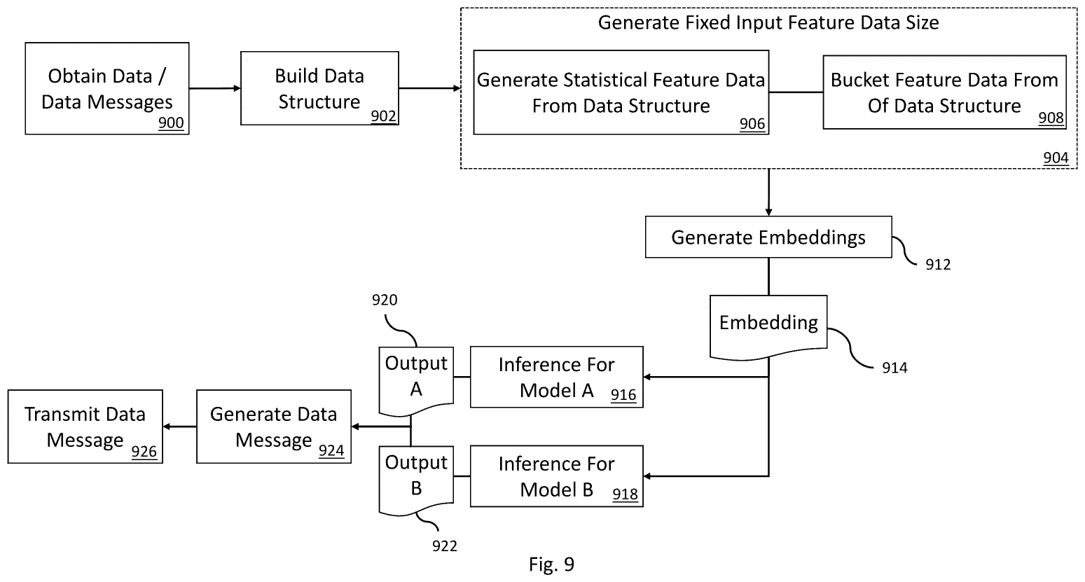

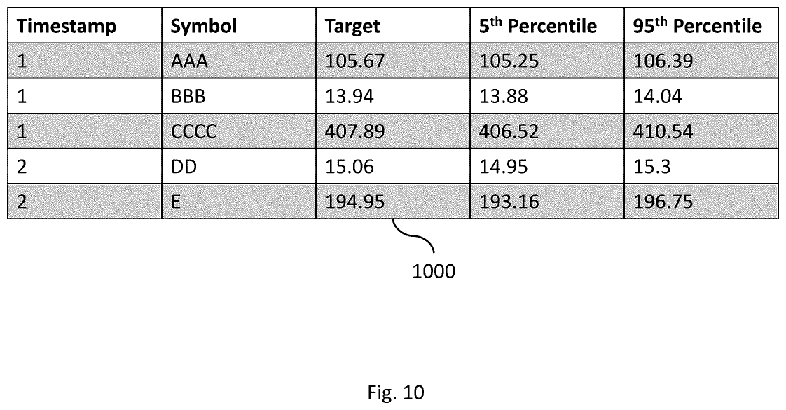

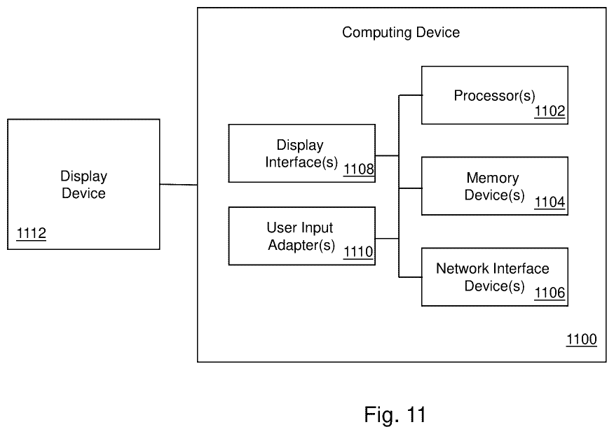

FIG. 1 shows a training computer system that generates trained models. FIG. 2 is an example process for training embedding and task models that uses the system of FIG. 1. FIG. 3 graphically illustrates the training technique used for training the embedding model of the process from FIG. 2. FIG. 4 graphically illustrates an example of an embedding model. FIGS. 5A-5B graphically illustrate the embedding model combined with different task models. FIG. 6 is an example of an order book and an order book with added statistical data. FIG. 7 graphically illustrates how multiple rows within an order book data structure are reduced to a fixed number in the fixed sized data structure. FIG. 8 is an example of a distributed computing system that uses the trained models (the embedding model and task models) to generate predictions that are communicated to clients using the process shown in FIG. 9. FIG. 10 is an illustrative example of the data communicated to clients based on the predictions provided by the task models. FIG. 11 shows an example computing system that may be used in some embodiments to implement, for example, the training computer system of FIG. 1, the distributed computing system of FIG. 8, or both.

In many places in this document, software (e.g., modules (e.g., feature generation module 106, machine learning training module 108/110, inference module 852, etc.), software engines (e.g., matching engine 810), processing instances, services, applications, and the like—and actions (e.g., functionality) performed by software are described. This is done for ease of description; it should be understood that, whenever it is described in this document that software performs any action, the action is in actuality performed by underlying hardware elements (such as a processor and a memory device) according to the instructions that comprise the software. Such functionality may, in some embodiments, be provided in the form of firmware and/or hardware implementations. Further details regarding this are provided below in, among other places, the description of FIG. 11.

### Description of FIG. 1: Training

FIG. 1 is an architecture diagram that shows an example computer system according to certain example embodiments. The computer system of FIG. 1 is a training computer system 100 configured or designed to generate one or more machine learned models 116 that may be deployed or used by distributed computing system 800. The training computer system 100 may be implemented using one or more of the computing device(s) 1100 that are discussed in connection with FIG. 11.

The training computer system 100 is configured to generate a machine learned model (e.g., a neural network, etc.) that is used to transform an input data structure into an embedding. The generated embeddings are then used to train additional models (e.g., models 116, 230, 232, etc.), as discussed below, for one or more tasks as appropriate for a given problem(s).

Training computer system 100 receives or obtains data messages 102. Examples of data messages 102 may include, or be based on, data transaction request messages that have been received by distributed computing system 800.

The data transaction request messages may include a command or request for an action to be taken by the distributed computing system 800—e.g., that causes a modification to the data structure maintained thereon. As an example, a data transaction request may include data for a new temperature reading and the request may be a request to add or update that data to a weather-related data structure being maintained by the distributed computing system 800. As another example, a data transaction request may include a request for the execution of a data processing job in a cloud computing environment. The distributed computing system 800 will then process that request by, for example, allocating appropriate processing resources (e.g., as represented in the data structure maintained by the distributed computing system 800) for that data processing job. In some examples, the data messages 102 may correspond to the data transaction requests and in other examples, the data messages 102 may correspond to the results of processing such data transaction requests against the data structure. In either case, a given data message may be associated with a change in state of the data structure.

The data messages 102 are stored to a database 104 and form the data that is used to train the models discussed herein. In some examples, the training computer system 102 has access to a database of such messages (and/or the results of distributed computing system 800 handling such messages).

Databases can include flat file storage, relational database systems, or other storage that involves storing data in manner that allows for future retrieval. In some examples, the data messages may be referred to or be stateful (stateful data messages) in that the ordering of application of those messages to a data structure is required for proper reconstruction of the state of the data structure at a given point in time. In some examples, the application of the stateful data messages to generate a view of the data structure at a given point in time converts the stateful data into a stateless view of the data structure at a given point in time. This advantageously allows for increased parallelization of processing as different generated views of the data structure do not depend (e.g., once the data structure is constructed for that point in time) on prior states.

The techniques herein may be applied in the context of electronic trading platforms. For example, the data structure discussed above may be an order book. Also, an example of a data transaction request message is a message that is received by an electronic trading platform (which is an example of distributed computing system 800). Such messages may include, for example, a unique (e.g., to that electronic trading platform) reference identifier to, for example, request an order (e.g., an electronic order) be entered to buy or sell a particular asset (identified by the unique reference identifier) that is processed by that electronic trading platform. An electronic trading platform can be designed to process data transaction request messages for many different unique reference identifiers. Such reference identifiers are commonly referred to as tickers, symbols, ticker symbols, stock symbols, and similar. These tickers are used by the electronic trading platform to uniquely identify a security, asset, or the like for which processing is performed by the electronic trading platform. Example tickers include “AAPL,” “IBM,” and “KO.” For ease of description herein the term “ticker” is used to refer to such unique reference identifiers.

In general, when such data transaction requests are processed by the electronic trading platform, one or more responsive messages and/or other artifacts will be generated. Examples include entry of new orders into an order book, cancelation of existing orders (or quantity from such existing orders) from the order book, execution of trades (e.g., matches between two or more orders which thereby modifies the order book due to the execution), replacements (e.g. of existing orders within the order book), and other actions that are performed by the electronic trading platform in response to reception of a correspond data transaction requests (e.g., a request for the electronic trading platform to take some action). The processing of such messages by the electronic trading platform may accordingly change the order book that is being maintained by the electronic trading platform. The processing of such actions and the messages generated that are reflective of that processing may accordingly be used to construct/reconstruct the state of the order book for a given ticker and at a given point in time. Correspondingly, each action (e.g., the processing of a data transaction request) that is taken by the electronic trading platform can represent a change in state of the electronic trading platform—or, more specifically, the order book data structure of a given ticker that is maintained by that electronic trading platform.

Data included in database 104 can correspond to each of these state changes for one or more tickers. Additional data that is included in the database 104 can include additional metadata about a particular ticker and other data. Examples include information on the electronic trading platform (e.g., country, operator, etc.), tick size associated with the ticker, currency information (e.g., exchange rates, etc.).

In some examples, the data for database 104 is provided directly to the training computer system 100 (e.g., without having to acquire individual messages thereof). For example, an electronic trading platform (or other computer system) may store data regarding processing performed by that system during operational periods. For example, an electronic trading platform may store data for all order entry messages, executions, cancellations, replacements, and other messages generated by the electronic trading platform during an operational period (e.g., a trading day). In some examples, different datasets from different individual electronic trading platforms may be compiled into database 104. For example, each electronic trading platform from 5 different countries may supply data into database 104 and these datasets may be used for the training processes discussed herein.

Training computer system 100 includes feature generation module 106, machine learning training module—embeddings 108, and a machine learning training module—tasks 112. Also included are databases 110 and 114 for storing, respectively trained embedding models and task models (discussed in greater detail below).

The feature generation module 106 is responsible for building the data structures that will be used to train a model (e.g., a neural network) to generate embeddings. In certain examples, the data structure that is built is an order book data structure or a data structure that is used to represent an order book. The data structure that is used to represent an order book (e.g., the state or a snapshot of the order book) may include hundreds of different features regarding that snapshot. The features may be statistical features that are generated on the fly (e.g., dynamically) or may be taken directly from the data structure for which a snapshot is being generated.

In many implementations, an electronic trading platform (e.g., via a matching engine or the like) maintains and/or has access to an order book data structure (which may also be referred to as an “order book” herein) to store pending (previously received) orders that are available to match against incoming orders. In some examples, the order book data structure is used to store those orders that have been subject to a match process but have not been matched (or only partially matched) to another order. In some examples, a separate order book may be used for each ticker. For example, if two different cryptocurrencies are traded on an electronic trading platform, the platform's matching engine will maintain a separate order book for each of the two cryptocurrencies. In some examples, and as described below, different order books may be maintained for the same ticker. Such different order books may hold different types of data transaction requests for the same ticker.

An example of a different type of order book that may be used in some instances is a closing auction or closing cross order book. With this type of order book, in some examples, orders are placed into the order book and then any, or all, of the orders are executed at closing as part of an “auction” process. The auction process may be implemented in different ways. An example auction process may be one that seeks to maximize the total number of shares of the received orders that can be matched given the properties of the orders within the order book (e.g., the price, volume, etc.). In some implementations, clients may submit orders that are entered into this order book minutes (e.g., 5 minutes) before this closing time. Further, as discussed elsewhere herein, the closing time may be subject to a random variability.

In any event, an order book can be structured to include two list data structures, with one of the list data structures including buy orders and the second list data structure including sell orders. Each list in the order book may be referred to as a “side” of the order book, and the order book data structure can be referred to as a “dual-sided” data structure in some instances. In some electronic trading platforms, where an order book for an asset is used, processing performed by a platform's matching engine may include use of the order book—e.g., by comparing the characteristics of an order (e.g., that may be newly received) to the characteristics of the contra-side orders for that ticker to determine if a match can be made.

Note that in an example electronic trading platform implementation, an order book data structure includes individual orders. Thus, for example, buy order 11234 (a GUID) may be for $50 and buy order 11235 may also be for $50. Each of these orders may be separately represented and stored within the order book of the example electronic trading platform.

In contrast to the order books maintained by electronic trading platform during operational periods, the feature generation module 106 constructs a view of an order book based on each price level of the order book. More specifically, the properties of the various orders are summed or otherwise combined at each price level. FIG. 6 illustrates an example of a view of an order book data structure that may be generated by the feature generation module 106 according to certain example embodiments. As shown in FIG. 6, buy and sell columns sum the total quantity at each price level (e.g., 103, 102, etc.). Note that as used herein, a “price” value may also be termed a “match value.” In other words, the match value may be the value at which matches are determined by the distributed computer system 800 (e.g., the matching engine thereof) and need not, in certain examples, be a “price.” Note that the order book that is generated by the feature generation module 106 may include additional features (e.g., columns) such as an imbalance indicator (e.g., “direction”) and/or imbalance amount (e.g., “imbalance”) and other features that would not traditionally be found within an order book maintained by an electronic trading platform.

In some examples, the feature generation module 106 may also be programmed to transform the generated order book into a fixed size that can more easily be used in the training process. A more detailed discussion of the generation of feature data is provided in connection with FIG. 2.

The training computer system 100 also includes a Machine Learning Training Module—Embeddings 108 that is used to train a model, such as a neural network (e.g., 400 in FIG. 4), that generates an embedding for a given input data structure (e.g., the order book representation produced by the feature generation module). As used herein, an “embedding model” is a model, such as a neural network, that has been trained to generate an embedding of input data (e.g., a view of an order book data structure). In some examples, the embedding model may be a sequence-to-sequence model (e.g., a recurrent neural network (RNN), long short-term memory (LSTM), or the like).

Models produced by Machine Learning Training Module—Embeddings 108 may be stored to a database 110. In some examples, only one model may be trained for generating embeddings. In other examples, different models may be trained depending on the nature of input data that is to be transformed to an embedding. For example, one model may be used to transform an order book type data structure, and another may be used to transform a data structure that corresponds to individual messages produced by distributed computing system 800.

The training computer system 100 also includes a Machine Learning Training Module—Tasks 112 that is used to train models for various tasks. More specifically, module 112 may train one or more models using the embeddings produced by the embedding model. The training may be performed using regression, back-propagation, and other machine learning techniques. As used herein a model trained by module 112 may be referred to as a “task model.”

The models trained by a Machine Learning Training Module—Tasks 112 are stored to trained model database 114. In some examples, the resulting models stored to database 114 may include the embedding model. Illustrative examples of the combined models include the graphical neural network representations shown in FIGS. 5A and 5B (e.g., 590 or 592). In other examples, the embedding model may be stored separately from each of the task models (e.g., 400 may be stored and used separately from 500 and 550).

The models that have been trained by the training computer system 100 may then be deployed for use by the distributed computing system 800 (discussed in connection with FIGS. 8 and 9).

In some examples, one or more models may be trained without using Machine Learning Training Module—Embeddings 108 as part of the training process, and correspondingly without storing trained embeddings to Trained Model(s)—Embedding 110. In some examples, a model may be trained using the feature generation module 106 that then trains a model for a given task via Machine Learning Training Module—Tasks 112. In other words, in some instances, the process of generating an embedding model (e.g., an embedding layer that is then frozen) may be skipped. It will be appreciated that the bucketing technique, embedding task, or the like may differ based on the nature of data and/or the down-stream task. Accordingly, in some examples, alternative embedding models may be used, different bucketing techniques used, or no embedding model or the like may be used. In other words, different tasks may lend themselves to different types of training techniques in order to generate a model for a given task.

In certain examples, the type of data on which a model is being trained may lend itself more to using embeddings or not. As noted herein, embeddings may act to focus the feature space for training a model resulting model and can assist with generating a final model. However, certain types of data may be less susceptible to working with first generating an embedding model (e.g., pre training an embedding model) and then using that embedding model to generate a task model. An illustrative example of different types of data may be a model that is trained to predict a final match value (e.g. a final matching price) at an auction and a model trained to predict a final match amount for the auction (e.g., how much is matched). In some instances, the prediction of a final match value may benefit from using embeddings. However, the prediction of a final match amount may not. In some cases, the difference in model training performance may be due to the initial order book states from which samples are generated, a given embedding task, a given bucketing technique that is being used, and/or any combination thereof. In the above example, the use of a given embedding task and/or bucketing technique can provide results that are more representative for the final match price than for the final match amount. Accordingly, in some examples, training an embedding layer (or using a particular type of embedding task and/or bucketing technique) may be more beneficial for certain types of predictions/certain types of data. In the above discussed example, use of the trained embedding layer was found to not be as advantageous for predicting volume as compared to price. However, in other examples, different types of embedding tasks and/or bucketing techniques may provide results that could be advantageous to prediction of volume (or other attributes).

In any event, in accordance with some examples, one or more models may be trained by using the Machine Learning Training Module—Embeddings 108 while one or more additional models may be trained without it. The differently trained models may then both be used when inference is performed (e.g., as discussed in connection with FIGS. 8-10).

As an illustrative example, one model may be trained to predict price (e.g., an execution price at the close of an auction) while another trained to predict volume (e.g., the total volume that will be executed or matched at close of the auction). The model for the prediction of price may be trained using the Machine Learning Training Module—Embeddings 108, while the model for prediction of volume may not use the Machine Learning Training Module—Embeddings 108. In other words, the model for prediction of volume may not include a pre-trained (e.g., frozen) embedding layer, whereas the model for prediction of price will have such a layer (e.g., generated from Machine Learning Training Module—Embeddings 108). As noted herein, it will be appreciated that other techniques may be employed depending on the nature of the data, the task involved, and/or other considerations.

Note that a model trained without the use of training an embedding model first may also be referred to as a “task model” herein (e.g., for the task for which that model was trained).

Accordingly, system 100 can be flexibility used depending on the nature of the model that is being trained (or the nature of the data that is being used to train the model).

### Description of FIGS. 2-7: Training

FIG. 2 is a flow chart of an example machine learning training process that may be performed by the computer system shown in FIG. 1 according to certain example embodiments.

At 200 the data that is to be used in the training process (e.g., for training both the embedding model and the task models) is gathered. As noted above, this data may be present within a database and/or may include messages that relate to state changes of the distributed computing system 800 (and/or one or more data structures maintained by the distributed computing system 800). Each of the messages that is included within the data may include a timestamp or other value to indicate a relative ordering to other such messages.

In the context of electronic trading platform implementations, each message may also generally be associated with a specific ticker or order book and/or a side (e.g., buy/sell) of the order book/ticker. Other data that is obtained as part of 200 may include metadata and other types of informational data. Such data can be used to provide additional details regarding, for example, the particular ticker, the particular distributed computing system 800, the country in which it operates, and other information that can be of use in the training process. It will also be appreciated that whenever techniques are discussed in connection with electronic trading platform implementations and aspects thereof herein, that such techniques may be similarly applied in an analogous fashion to the weather, traffic, processing allocation, and the like examples that are also discussed herein.

At 202, a view of the data structure at a specific time is generated. In the context of electronic trading platform implementations, this may be performed for each of the tickers for which data has been gathered. This view may be represented as a data structure (with the illustrative data structure 600 in FIG. 6 being an example) that holds the various pieces of data that represent the data structure at that given time. These views may represent the data structure at different periods of time throughout the day (e.g., an operational period, such as a trading date). In some examples, the views that are generated may not be uniform throughout the day (e.g., once every minute). Rather, in some examples at 202, more views may be generated per unit of time at the end and beginning of the operational period. In some examples, order book data may only be generated in connection with the closing auction process that is discussed herein.

As noted herein, and in some examples, different order books may sometimes be used for the same ticker. An example of this is a closing auction order book. And in certain examples, the order book that is generated may be based on messages and/or data associated with the closing auction order book as opposed to the “regular” order book that is used throughout a typical trading day. In the case of building an order book associated with the “closing” auction process, the order book data structure that is generated may add a time field for the amount of time to when the auction closes (e.g., a remaining time value or time remaining value). In certain examples, the auction time period may have a random variable ending. For example, if an auction process occurs over the last 5 minutes of the trading day, then the auction process may be triggered to close at any time during the final 30 seconds. In such cases, the “remaining” time that is associated with the order book state may be the time until the variable closing period.

In any event, representations of the state of the data structure at different times may be generated using the information from the obtained data (e.g., entries, cancels, executions, replacements, other data, etc.). Note that the generated order book may include representing each price level of the order book as a row within the resulting data structure. For example, referring to FIG. 6, price level 102 includes 100 buy side quantity and 300 sell side quantity.

In the case of machine learning problems that are used for closing auctions, each order book that is generated may be associated with the final auction closing price that was determined for that closing auction. This information, in combination with the state of the order book (e.g., the equilibrium price, also called an equilibrium match value herein) may assist in developing a machine learned model that can generate, in real-time (e.g., less than 5 seconds, less than 1 second, or faster), a price value at which the closing auction is predicated to use.

Once the data structure has been generated at 202 (with the order book 600 from FIG. 6 being an illustrative example), then at 210, the process transforms the generated data structure into a fixed size. This step includes generating statistical data feature data (e.g., 602 in FIG. 6) that may then be included at 206 into the resulting fixed size data structure. The statistical data may include aggregations (e.g., averages and the like) and other data that can be used to assist in training the neural network.

In addition, at 208, the transformation to the fixed sized data structure also buckets the data from the data structure into a fixed size. This occurs by bucketing the various rows of the data structure (e.g., the price levels in the order book example) into one of multiple preset (or computed) buckets. The bucketing (also called windowing, banding, etc. herein) may be based on one or more data values of the data structure (e.g., any of the columns in 600 or 602) Thus, for example, the data for the various price levels of an order book data structure (the ‘Price” column of 600) may be correspondingly compressed (e.g., by averaging the data or the like). In the context of price levels, the bucketing discussed herein may also be referred to as (also called “price level windows,” “price level bands,” “match level windows,” “match level buckets,” or “match level bands” herein)

FIG. 7 illustrates the bucketing process for an order book example where the top two rows (price level 98 and 99) of 610 are bucketed into the same data row of the fixed size data structure (e.g., the top row) 620. Similarly, the bottom two rows of 650 are bucketed into the bottom row of the data structure 660.

In certain example embodiments, the number of price level buckets may be predefined, dynamic, and/or configurable and based on different target data. In certain examples, the buckets may be generated based on a percentage away from a calculated equilibrium price (also called an equilibrium match value) for that order book. In other examples, a midpoint value or other calculated value for the data structure may be determined. In certain examples, the price bands are then calculated based on the calculated equilibrium price. Illustrative examples may be, for example, (3+%) (2-3%), (2-1.25%), (1.25-1.1%), (1.1-1%), (1-0.9%), (0.9-0.8%), etc. These percentage bands may be, for example, percentage points away from the calculated equilibrium—or other value that may be used. Similar bands for negative percentage values may also be used. There may be as few as 10, but as many as around 100 different bands (e.g., 10s of bands) depending on the particular training result that is desired (e.g., the level of granularity that is desired for a particular problem). In certain examples, the range of the bands may become narrower the closer a given band is to the equilibrium price as represented in the data of the data structure at that time. As the bands are based on percentages, the coverage of a given band may be automatically determined as part of the processing performed at 210 as a function of a calculated equilibrium price. Accordingly, for example, each price level (or other value as needed) in the arbitrarily sized data structure may be incorporated into a corresponding band (e.g., a row) of the fixed sized data structure.

Once the fixed sized data structure (which is uncategorized/non-classified) is generated, then it may be categorized at 212. Specifically, each generated fixed sized data structure is assigned a class label. The assigned class labels in certain examples will be used to facilitate training a neural network to translate the given input data (e.g., the state of a data structure at a given point time) into an embedding that represents “where” that data structure is located within an E-dimensional space (with respect to other instances of that data structure). Advantageously, the class labels are assigned automatically using the techniques discussed herein.

In certain example embodiments, the labels that can be applied to each generated fixed-sized data structure may be one of 6 different classes (3 positive classes, and 3 negative classes). The class label that is assigned may be selected based on the percentage difference between, as one non-limiting illustrative example, the equilibrium value in the data structure (such as the equilibrium price of the order book) in its current state and a final value that as associated with that data structure (e.g., the final close price for the closing auction that was associated with that order book). A non-limiting illustrative example for the classes that may be used in certain example embodiments are as follows: 1) >2% change, 2) 2-1%, 3) 1-0%, 4) 0-−1%, 5) −1-−2%, and 6) <−2%. In some examples, each of these may correspond, respectively, to labels A, B, C, D, E, and F (e.g., six different labels).

However, it will be appreciated that other classes or definitions of classes may be selected or used depending on the nature of the machine learning problem or task being addressed. Additionally, fewer than 6 classes may be used in certain examples (e.g., as few as 2, or between 3 and 5 classes). It will similarly be appreciated that if fewer classes are used (e.g., just 2 classes, one class and another class, for example), then the model may be trained in a manner that results in “better” performance for a given problem. However, the model may also not be able to recognize more granular changes in the input data. Conversely, training a model with many classes may be more difficult and/or require more processing resources and/or data for such training. As discussed herein, it was determined that this example technique (e.g., including the use of about 6 classes for the labeling process) provided for improved results over other approaches or other training options.

Once the classes are assigned to the input data, then the process generates samples from the label input data at step 213. In certain examples embodiments, each sample that makes up the training data is a tuple of an anchor input, a positive input, and a negative input. A graphical representation of such tuples is shown as 300 in FIG. 3. As an example, the samples may include tuples with input data that is in Class A (e.g., the “anchor input”-Aa in FIG. 3), and one additional input that is also in class A (this is called the “positive input”-Ap in FIG. 3), and then one input from another class (e.g., B, C, D, E, F) that is called the “negative input” (Bn, Cn, etc. in FIG. 3).

The generation of the sample data may be repeated with each of the various classes being set as the anchor with corresponding positive and negative input for each sample that is generated.

With the sample data prepared, the training of the neural network begins at step 214. In certain examples, the training that is used in step 214 is N-Paired loss.

The training learns the weights of the neural network such that As are close to one another (e.g., grouped), while As are further away from the other classes (e.g., Bs, Cs, etc.). This is graphically illustrated as 350 in FIG. 3 with A samples being moved closer together within the E-dimensional space and other, non A-labeled, samples being moved away from A within the E-dimensional space. With the same holding true for the different classed samples. In other words, the training process proceeds with the goal of optimizing for a minimum distance between like class members while maximizing distance from the other classes.

The following pseudo-code is for a non-limiting example algorithm that may be used for training is provided below in Tables 1 and 2. Table 1 shows the algorithm for the N-Paired Loss Function. And Table 2 shows the algorithm for the N-Paired Loss Training that uses the Loss function from Table 1.

TABLE 1
Example Loss Function

Input
anchor embeddings: A list of anchor embeddings
positive embeddings: A list of positive embeddings
negative embeddings: A list of negative embeddings
margin: A margin hyperparameter
Output:
loss: The computed n-pair loss
Procedure:
1. Initialize the loss to 0.
2. For each anchor sample, positive sample, and negative sample:
a. Compute the sample embedding by inputting into model
b. Compute the pairwise similarities between the anchor and positive
embeddings and between the anchor and negative embeddings.
c. Compute the difference between the similarity scores of the anchor
positive pair and the anchornegative pair.
d. Add the loss term for this triplet to the total loss.
If the difference is less than the margin, add the difference to the loss.
Otherwise, ignore the triplet as it already satisfies the margin.
3. Divide the total loss by the number of triplets to compute the average
loss.
4. Return the average loss.

TABLE 2
Example Loss Training

Input
anchor: A set of anchor samples
positive: A set of positive samples corresponding to the anchors
negative: A set of negative samples
learning rate: The learning rate for the optimizer
batch size: The number of triplets in each training batch
num_epochs: The number of training epochs
Output:
Trained Model
Procedure:
1. Initialize the model architecture.
2. Initialize the optimizer with the chosen learning rate.
3. For each epoch from 1 to num_epochs:
a. Create batches of triplets: anchor samples, positive samples, and
negative samples.
b. For each batch:
Forward pass: Pass the anchor, positive, and negative through the
model.
Compute the n-pair loss for the embeddings.
Backward pass: Compute gradients and update the model's
parameters using the optimizer.
4. Return the trained model.

As noted above, the training at this stage trains a neural network to generate an embedding (e.g., an E-dimensional vector) that represents where a given piece of input data (e.g., a given order book state) is with respect to other pieces of input data (e.g., other order book states). In general, a neural network embedding (or generating embeddings via a neural network) is a learned low(er)-dimensional representation (e.g., in vector form) of discrete data in the form of a continuous vector.

Model training may continue with new or additional data until performance reaches or exceeds a given threshold (e.g., until convergence of the model, when the loss no longer decreases for each sample or group of samples, or the like). In certain example embodiments, multiple months of historical data may be used to train a model using the techniques discussed herein. The historical data may include, for example, snapshots of the state of an order book for every second during an auction process—and for 10s or hundreds of different tickers. Accordingly, training may involve millions of different states of the same data structure (e.g., different states for an order book).

An illustrative example of the model produced by the processing at 214 is 400 in FIG. 4. It will be appreciated, however, that model 400 is provided by way of example and that in certain examples, the size of the model may be larger—perhaps considerably so. For example, while model 400 shows 16 dimensions (E) for the resulting embedding, other models that have been trained may have 100s of dimensions (e.g., the resulting size of the vector of the generated embeddings). It will be appreciated that increasing the dimensionality of the embedding allows for increased differentiation (e.g., just as 3-dimensional modeling allows for increased differentiation over 2-dimensions).

Once the model (e.g., neural network) is trained per 214, then the weights of the neural network are frozen at 216 and the model is ready to be used for the second stage of the training process at 218.

Second Training Stage 218 involves using the embeddings generated by the previously generated neural network to train one or more additional models to perform predictions given the state of the embedding for input data structure (e.g., the state of an order book). In some examples, the same input data used to train the embedding model may be used for the training performed at 218. In other examples, different input data may be used.

At 220, a first model is trained using the generated embeddings. In some examples, this model is trained using machine learning regression and back-propagation techniques. The task for which a model is trained may be to predict a given value from the provided input data structure. The given value may be, for example, a prediction of the price that is used in the closing auction given the state of the order book at a given time (e.g., as represented in the embedding). For this problem, as the remaining time to the auction approaches 0, the difference between the price value predicted by the model and the final actual closing price may converge. As noted elsewhere herein, the techniques used in training the embedding model and the task model may result in an improvement over prior techniques of providing predictions.

It will be appreciated that the while the techniques herein as discussed in the context of an example electronic trading platform, that the techniques may also be applied in other contexts. For example, a data structure that represents a current state of weather may be used to train a neural network to generate embeddings thereof. Subsequently, additional task models may be produced to generate predictions regarding various aspects related to the weather (e.g., likelihood of rain, potential solar output, etc.).

Table 3 includes pseudo-code for an illustrative algorithm that may be used in certain example embodiments for training a neural network (e.g., a task model).

TABLE 3
Training A Neural Network Using Backpropagation

Input:
training_data: A set of training examples (e.g., embeddings)
learning_rate: The learning rate for the optimizer
num_epochs: The number of training epochs
Procedure:
1. Initialize the weights and biases of the neural network
randomly or using aspecific initialization method.
2. For each epoch from 1 to num_epochs:
a. Shuffle the training_data to introduce randomness in the order of
training examples.
b. For each training example (input, target) in training_data:
Perform a forward pass through the neural network to compute the
predicted output.
Compute the loss between the predicted output and the target
(e.g., the task or the like).
Perform a backward pass (backpropagation) to compute the
gradients of the weights and biases.
Update the weights and biases using the gradients and the
learning rate.
3. Return the trained neural network.

An illustrative example of an example model trained from 220 is shown as 500 in FIG. 5A. Here, for a given target value, there are log (E) target cells with hidden dims (e.g., E, E/2, E/4, . . . , 1). The result output is the predicted value (e.g., the predicted price at which a closing auction will execute at).

At 222, a second model is trained. This model may be trained to output different values given the same input data (the embedding produced by the embedding model). In some examples, the task may be to produce two quantile target values (e.g., that represent 5 and 95 percent confidence intervals). The quantile target values may be, for example, upper and lower bounds associated with the predicted value from 220. In some examples, step 222 may use Upper/Lower Quantile Regression techniques in order to generate a model that provides such quantile output.

An illustrative example of a resulting model trained from 222 is shown as 550 in FIG. 5B. Here, for a given target value, there are log (E) target cells with hidden dims (e.g., E, E/2, E/4, . . . , 2). The resulting output is the two predicted quantile values, which are upper and lower bounded values associated with the predicted value produced by model 500 in FIG. 5A.

Once the model training from 220/222 is complete (e.g., the models have converged), the resulting models (230, 232) may be output and delivered to/used by the distributed computing system 800. In some examples, models 230 and 232 may include the embedding model 400 (e.g., as illustrated in FIGS. 5A and 5B). In other examples, models 230 may include models 500 and 550, with the embedding model 400 provided separately to the distributed computing system 800. In some examples, the models may be stored as one model. For example, model 590 is the combination of embedding model 400 with model 500, while model 592 is the combination of embedding model 400 with model 550. In some examples, the models may be packaged into a docker container package or the like, stored to memory, and then delivered to the computing system that may then run the docket container and the models included therein.

Note that while the illustrative examples of Price and Quantiles are provided, additional task models may be trained as part of 218. In some examples, additional models may be trained to provide predictions indicate an order imbalance (at the execution of the closing auction), a total volume (at the execution of the closing auction), a percentage of orders that will execute (either whole and/or in part), odds that a give data transaction request will execute at a given price value at the close of the auction, a predicted price value at which there is a given percentage chance of a given data transaction requests being matched at the auction, and the like.

As noted in connection with FIG. 1, in some instances (e.g., for some types of models/data), depending on the structure and complexity of the data, the embedding task and procedure from 212, 213, 214, and/or 216 may not be a preferred approach and other, alternative embedding methods (or other auxiliary tasks that may help the model understand the high level structure of the data) may be used. In other examples, any or all of 212, 213, 214, and/or 216 may be skipped. and a given task can be trained (at 218) using data generated from 210. As explained herein, generating a model to predict volume is an illustrative example of this. In such cases, the entirety of model 590 (or 592) may be trained via 218 rather than just, for example, 500 or 550.

While the above non-limiting illustrative examples are discussed in the context of electronic trading platforms and task models for such platforms, different task models may be trained for different types of systems and problems. For example, in the context of a system in which embeddings are generated based on a data structure that represents traffic data, different task models may be trained on various traffic related tasks or problems. One task model may provide a prediction of travel time for a given vehicle (either at a current time or a time in the future), another a prediction of a future traffic volume, and another a prediction of travel times from one location to another.

In the context of a system that generates embeddings of a data structure of the allocation of cloud computing resources for submitted processing tasks, different task models may be trained. Such task models may include the prediction of future processing loads across a cloud computing platform (e.g., to predict when new processing nodes are needed or not), prediction for the amount of time the processing for the given task will take, and the like.

In the context of a system that generates embeddings of weather data, different task models can be trained for various tasks that may be performed with such data. Example task models may include a prediction of a future temperature based on the current embedding data, a prediction of wind speed, and the like.

As the techniques herein may be flexibility deployed in different contexts, the type of data that is included within the dataset for which an embedding is generated may include combinations of different types of data. As an example, weather data and cloud computing data may be included into a dataset for which an embedding is generated. Different task models may then be developed based on that data. As an example, a task model that predicts power consumption of a data center given the weather and processing load (both of which are represented in the generated embedding) may be created.

Accordingly, an advantageous aspect to the techniques herein is that the embedding model may be leveraged in performing further and/or multiple specific machine learning tasks to make predictions. For example, the same embedding data can be used to train two or more different models that perform different tasks. This is advantageous as the process of training the model that is used to generate the embeddings does not need to be repeated for each task model. The advantages of this are discussed in greater detail in connection with FIGS. 8 and 9.

### Description of FIG. 8: Inference

FIG. 8 is an architecture diagram that shows an example computer system that uses the trained model(s) generated by the system of FIG. 1 according to certain example embodiments. In the example shown in FIG. 8 the computer system shown is a distributed computing system 800. This system is distributed in that the various components of the system (discussed below) may be provided on separate hardware resources (e.g., separate processors, memories, computers, or the like).

The distributed computing system 800 may be realized in different forms. In some examples, the dual-sided data structure of the distributed computing system 800 may be used to allocate cloud computing resources for submitted processing tasks. The cloud computing resources may be represented on one side of the data structure and requests for processing tasks may be represented on the other side of the data structure. The distributed computing system 800 may operate by allocating (e.g., matching) those tasks to one or more of the processing resources. In another example, the distributed computing system 800 may maintain a data structure regarding the current state of metrological data that includes data from various sensors and the like. Data transaction requests that are submitted to the distributed computing system 800 may include requests to, for example, record a temperature increase or an increase in wind speed, or the like. In another example, the dual-sided data structure of the distributed computing system 800 may represent components of a factory floor on one side and materials used by those components on the other. The distributed computing system 800 may seek to match the materials to the components for use in the factory. In some examples, the distributed computing system may be realized as an electronic trading platform. Non-limiting illustrative examples of electronic trading platforms include the electronic trading platforms that are used to operate exchanges such as Nasdaq Copenhagen, Nasdaq Stockholm, Nasdaq Helsinki, the Nasdaq Stock Market, the Frankfurt Stock Exchange, Euronext, the London Stock Exchange, the New York Stock Exchange (NYSE), and others.

Components of the distributed computer system 800 may include order port 806, incoming data feed module 806, outgoing data feed module 808, matching engine 810, closing module 812, and inference module 852 (which is party of the machine learning subsystem 850). Each or any of these components may operate within their own process space on a computer system and/or may operate on their own dedicated computing device(s) 1100 (discussed in FIG. 11). In some examples, each or any of these components may operate within their own virtual environment (e.g., a docker container or the like) and communicate with other components using a data communications network or subsystem.

Distributed computer system 800 communicates with client systems 802 that submit data messages, including data transactions requests 804, to the distributed computer system 800 for processing. The data messages are received by an order port 806 (which may also be called a gateway in certain examples).

Order port 806 is configured to receive and process messages from, among other systems, client systems 802. Order ports may be arranged in a physical (e.g., a separate physical wire or the like) or logical manner (e.g., a separate TCP port or the like). Order ports may be responsible for performing initial validation of incoming messages and, as appropriate, annotating such incoming messages with additional values or fields. For example, a client ID may be appended to a newly received message that is received from a particular client system. In some examples, specific order ports are bound or assigned to specific clients. Once a new message has been validated, it may be communicated to one or more other components of the distributed computer system 800 using a data subsystem or the like (e.g., an internal communication bus). In some examples, order port 806 also communicates messages back to client system(s) 802. Such messages may include acknowledgments or messages regarding the status of a previously submitted data transaction request. In some examples, the newly received messages may be communicated to a sequencer for sequencing, which then sequences the message, and communicates that message (or a version thereof) to all other components distributed processing system 800. In some examples, the sequencer is part of, or a component of, the matching engine 810 (e.g., it operates in the same process space). In some examples, the order port module 806 may store data locally (e.g., ticker symbol lookup, etc.).

Incoming data feed module 809 is responsible for interfacing and receiving data messages from third party systems that provide data to the distributed computer system 800. In some examples, the data is provided as part of a data feed or the like. An example of such a data feed may be one or more SIP (security information processor) data feeds that provide NBBO data and the like to electronic trading platforms. Another example of a data feed may be a weather feed or a traffic feed that provides data messages concerning weather or traffic updates. In some examples, the incoming data feed module 809 may store data locally (e.g., ticker symbol lookup, etc.).

Outgoing data feed module 808 is responsible for communicating data feeds to external third-party computer systems, which may also include client system(s) 802. As discussed in greater detail below, the outgoing data feed module 808 may handle communicating the target (e.g., price) and quantile data that has been generated by the machine learning subsystem 850. In some examples, the outgoing data feed module 809 may store data locally (e.g., lists of subscribers, ticker symbol lookup, etc.).

In the context of a non-limiting example of an electronic trading platform, the components of the distributed computer system 800 may include a matching engine 810, which is a module that is programmed to perform, and performs, a process to determine matches between orders. For example, if a data transaction request message is received that indicates an order to buy an asset for ticker A (and/or some quantity thereof), the matching engine 810 may perform a process to compare this buy order against corresponding or complementary sell orders (i.e., which also reference ticker A) to determine whether a match can be made. This processing may be performed by matching engine 810 to determine whether a match can be made may be referred to as “match processing” or “match operations,” or as performing or executing a “matching process,” or similar.

The matching engine 810 also maintains and/or has access to an order book data structure (which may also be referred to as an “order book”) 814 to store pending (previously received) orders that are available to match against incoming orders. In some examples, the order book data structure is used to store those orders that have been subject to a match process but have not been matched (or only partially matched) to another order. In some examples, a separate order book may be used for each ticker. For example, if two different cryptocurrencies are traded on an electronic trading platform, the platform's matching engine will maintain a separate order book for each of the two cryptocurrencies. In some examples, and as described below, different order books may be maintained for the same ticker. An example of this would be a continuous order book and a closing auction order book. Each of these orders books may hold different orders for the same ticker symbol.

Another module of the distributed computer system 800 is the closing module 812. In some implementations, an electronic trading platform may include a process that handles end of day matches by holding an auction process. In some implementations, the auction process operates in two phases. During a first phase, client systems submit data transaction requests that are stored within a closing order book (e.g., separate from a continuous order book). Then, during a second phase, a closing time is triggered, and no new orders are accepted. The closing module 812 determines a closing price and executes or matches those data transaction requests in the closing order book at a price that maximizes the total quantity of traded shares from those data transaction requests that where in the order book at that closing time. In some examples, the time at which closing is triggered may be randomized. For example, the closing time may be selected at any point within a 30 second window.

In certain example implementations of the auction closing process, there may be no pre-trade, or per order transparency into the closing order book. Rather, in certain examples, data messages may be provided to third party systems via the outgoing data feed module 808 that are based on a current state of the closing order book.

It will be appreciated that other implementations of a distributed computer system 800 may include different or other types of components in accordance with the type of implementation for that particular platform. For example, a weather platform implementation of the distributed computer system may include data storage for the various sensor readings that are received from external sensors. A location module may generate an input dataset (from the sensor data) for a request for a weather report (e.g., a prediction of the weather). In another example, a cloud computing allocation platform may include an allocation module for determining how incoming task requests are to be allocated to available processing resources (or how incoming processing resources are to be allocated to available tasks). Accordingly, it will be appreciated that appropriate components or modules may be included in accordance with the respective functionality provided by an example platform.

In addition to the components described above, the distributed computer system 800 may also include (or communicate with) a machine learning subsystem 850 that includes an inference module 852 that operate with pre-trained models (as discussed in connection with FIGS. 2-7) that generates an output signal 856. Details of the inference module 852 and its processing are discussed in greater detail in connection with the flow chart of FIG. 9.

The output signal 856 generated by the inference module 852 is provided to the outgoing data feed module 808 that then provides one or more data messages to third party systems regarding the signal that was output from the performed inference. As noted above, there may be one or more (e.g., 3) values that are generated when inference is performed according to certain example embodiments.

In some examples, the machine learning subsystem 850 is part of the distributed computer system 800 (e.g., it reads messages from a data subsystem that are produced by the matching engine 810/or sequencer thereof). In other examples, the machine learning subsystem 850 is hosted or part of a computer system that is remote from the distributed computer system 800 and data messages regarding the order book state (e.g., of the closing order book) are communicated to the machine learning subsystem 850 via a separate data feed. In some examples, the machine learning subsystem 850 may be provided as part of cloud computing environment and is run within, for example, a docket container or the like.

In some examples, the machine learning subsystem 850 may have direct access to the memory in which the order book(s) 814 are stored and may thus access data regarding the order book directly. In other examples, the machine learning subsystem 850 may be provided in a separate process space and/or by a separate computing device that is different than the one handling the auction and/or matching process. In some examples, the inference module 852 operates within its own process space, within its own virtual machine (or a docker container or the like), or otherwise operates on a separate computing device. In some examples, the inference module 852 receives and process data messages from the matching engine 810, closing module 812, the order ports 806 (e.g., copies of data transaction requests submitted from client systems 802) and/or other components and generates its own version of the order book that is then used in performing the inference processing. For example, the inference module 852 may maintain its “own” version of the order book that is updated based on reception of each new message that is received from the closing module, matching engine or sequencer thereof, and/or order port. This version of the order book may be referred to herein as a local version of the order book that is locally accessible (e.g., in locally accessible memory) to the processing that is performed by the inference module 852.

In some examples, the machine learning subsystem 850 may communicate the output signals back to distributed computer system 800, which may then communicate them to external computing systems. Alternatively, or additionally, machine learning subsystem 850 may directly provide such messages to third party computer system (e.g., without first communicating the results back to distributed computer system 800).

### Description of FIGS. 9-10: Inference

FIG. 9 is a flow chart of a process that may be implemented on the distributed computer system of FIG. 8 to generate output data from a trained machine learned model. FIG. 10 is an example of the data that can be generated and included into messages communicated to clients when the computer system of FIG. 8 uses a trained model and the process of FIG. 9 according to certain example embodiments.

In some instances, the process that is shown in FIG. 9 may be operated at a rate of about once per second. In certain examples, faster or slower rates at which inference is performed may be used. In certain examples, the inference process of FIG. 9 may be executed each time a new data message is received that changes the state of the data structure (e.g., an order book). In some examples, this may be combined with performing inference at a set rate. For example, every 1-second inference is performed and also inference is performed each time a target data structure changes state. As noted herein, the inference processing may be performed in connection with individual ticker symbols and their corresponding order books. Accordingly, for example, if there are 50 tickers on an exchange, then the inference process in FIG. 9 may be run 50 times each second (one for each order book). It will be appreciated that the same pre-trained model(s) (e.g., as discussed in FIGS. 1-7) may be used for any or all of the different ticker symbols.

In some examples (e.g., in electronic trading platform implementations), the rate at which inference is performed may vary from ticker to ticker. Some tickers may have inference performed at a rate of once per second, others at 5 times per second, and still others once every 10 seconds. In some examples, the update rate may vary based on the time of day or how long until the close of the auction. For example, at the beginning of the auction the rate at which inference is performed is once every two seconds, but towards the end of the auction the rate may gradually change (e.g., to an update every 1.5, then 1, and then 0.5 seconds). In some examples, the update rate may be set as a function of, or otherwise based on, the total number of data transaction requests and/or volume that has been submitted for a given auction for a given ticker. Thus, for example, tickers with more volume, action, and/or liquidity may have increased rates at which inference is performed versus other tickers that have lower volume, less action, and/or less liquidity (or other metrics as appropriate). In some examples, the rate at which inference is performed may be separate from the rate at which the results of the inference are communicated to client systems.

The inference rate may be controllable in other types of example implementations. For example, in the context of a cloud computing allocation platform (or a platform for making predictions for allocation of tasks to cloud computing platforms), the inference rate may depend on, for example, the compute power (e.g., in terms of CPU speed, memory availability, memory bandwidth, etc.) of each processing resource instance. In some examples, the inference rate may vary based on the nature of which one of multiple possible cloud computing platforms to which tasks may be allocated. As another example, in the context of a traffic prediction platform, the inference rate may depend on the time of day (e.g., morning/evening) or whether it is, for example, a workday or not.

Similarly, in certain examples, the same pre-trained model(s) may be used for any or all of multiple different platforms. It will be appreciated, however, that if the characteristics of a particular platform (for example an electronic trading platform or associated order books/tickers) are different, then a different model may be trained with applicable data (as discussed herein) and be used for that platform or the like. An example of this may be if some closing order books (and/or operations performed at closing of an electronic trading platform) operate in conjunction with a continuous book or not. Other examples may include different types of securities (e.g., bonds or equities, different electronic trading platforms (or different types of such platforms—e.g., that may have different types of match processing or the like).

Turning now to the execution of the process shown in FIG. 9, at 900, the raw data on which inference will be based is acquired. As noted above, this may involve receiving individual data messages and correspondingly building and/or maintaining a data structure (e.g., an order book) at 902. In other examples, a snapshot of the data structure (e.g., order book 814) may be provided in lieu of dynamically building the data structure on the fly.

At 904, the data structure is converted into a fixed sized format. Additional details of this conversion are discussed in connection with FIG. 2 and are similar for the inference processing. Specifically, the processing includes, at 906, generating statistical data from the data structure. This may include accumulating data from multiple rows of the data structure into one, calculating average values, taking the min/max, and the like. For example, if 500 different computing nodes are available to be allocated then the average compute power of those nodes may be determined and added. As another example, if each of the computing nodes is represented as a different record in the data, the total number may be summed and represented as a single record in the data, with an average compute power of the underlying computing nodes being used for that record. As another example, the percentage of available compute power out of a total may be represented (e.g., if 75 out of 100 are available, then this may correspond to low utilization). In the context of a traffic platform implementation, statistical data such as the total number of cars on the road at that time, the average temperature outside, and the like, may be determined and used to enrich the data associated with the data structure for which a prediction will be made. In the context of an electronic trading platform example, when an order book is used, statistical data such as accumulated shares, remaining time for the first phase of the auction, and the like may be calculated and included.

At 908 the rows from the data structure are compressed. In the context of an electronic trading platform example, the various price levels of the order book are grouped into one of multiple buckets. In general, this will reduce the number price levels because, for example in the fixed sized format, the price levels may be represented on a percent basis from an equilibrium price (e.g., or other midpoint value). Further, as discussed above, there may be between 10 and 50 such buckets, such as about 25 or 30. Whereas the non-fixed size version of the order book data structure may not be limited. In other examples, different types of bucketing strategies may be used depending on the particular application need. As another illustrative example, each car on roadway may be represented within the data structure (e.g., with various properties such as speed, type of car, etc.). In such an example, the speed at which cars are traveling may be bucketed into different groups (which those group then be averaged or otherwise modified to take into account the combination of the data). In the context of, for example, a cloud computing allocation platform, if each individual task or processing resource is represented, then those may be bucketed based, for example, the size of the task request. It will be appreciated that the nature of how individual rows are bucketed may depend on the nature of the prediction to be generated by the ML models described herein.

Once a fixed size data structure format for the input data is generated at 904, then, at 912, it is applied to the embedding model to generate an embedding 914 for that data structure state at that time. As noted herein, the time value associated with an order book state may be the amount of time left to when the auction process may close (e.g., the start of the random variable period in which the auction process may close).

Once the embedding is generated, then it may be applied to multiple different pre-trained models at 916 and 918. The processing for 916 and 918 may occur in parallel, sequentially, synchronously, or asynchronously. Advantageously, the embedding is used in the processing for (at least) two separate task models. Accordingly, the embedding may only need to be generated once. This type of technical improvement saves processing time and/or resources as each task model does not need to independently generate the embedding. Rather, the embedding may be generated once (e.g., the embedding model is executed once per input data). Then the generated embedding can be used in multiple subsequent or downstream executions of additional trained machine learned models.

As discussed elsewhere herein, for some data sets, embeddings may be unnecessarily cumbersome or the like, and/or alternative techniques for generating an appropriate embedding procedure may be used. Accordingly, in some instances, 912 may be skipped (or modified) and the fixed input feature data may be applied directly to the model for which inference is performed.

The output from the task models is, respectively, output A and output B. As noted herein, an example of output A may be a predicted closing auction price for an order book. An example of output B may be a 5^{th} percentile price in conjunction with a 95^{th} percentile price. These two values thus provide a confidence range for the price that is being predicted.

In some examples, the output values may be further modified to be, for example, valid values at which a closing price could occur (e.g., a valid tick value for that given ticker or the like).

At 924, the outputs are used to generate a data message that is then transmitted to third party computer systems at 926. An example of the data included in this message is shown in FIG. 10.

In some examples, a computer system (e.g., client system(s) 802) that receives the data message transmitted at 924 may process that message. The processing that is performed may include submitting one or more data transaction requests (e.g., orders) to the distributed processing system 800 that are based on the data include the data message communicated at 924. Such subsequent data transaction requests may then be added to the dual-sided data structure (e.g., to modify it), which may then further adjust additional predictions that may be generated according to the techniques discussed above. In some examples, the processing performed based on reception of the data message from 924 may include automated processing of the data in the message that results in communication of the subsequent data transaction request to the distributed processing system 800. The automated processing may include performing inference processing on a trained model (e.g., a neural network) and/or other programmatic. Accordingly, the data that is communicated to such computer systems may cause or trigger additional actions that includes processing on such computer systems and/or data messages communicated back to the distributed processing system 800 that may include further data transaction requests (such as the transmission of new order requests or the like).

### Description of FIG. 11

FIG. 11 is a block diagram of an example computing device 1100 (which may also be referred to, for example, as a “computing device,” “computer system,” or “computing system”) according to some embodiments. In some embodiments, the computing device 1100 includes one or more of the following: one or more processors 1102 (which may be referred to as “hardware processors” or individually as a “hardware processor”); one or more memory devices 1104; one or more network interface devices 1106; one or more display interfaces 1108; and one or more user input adapters 1110. Additionally, in some embodiments, the computing device 1100 is connected to or includes a display device 1112. As will explained below, these elements (e.g., the processors 1102, memory devices 1104, network interface devices 1106, display interfaces 1108, user input adapters 1110, display device 1112) are hardware devices (for example, electronic circuits or combinations of circuits) that are configured to perform various different functions for the computing device 1100. In some embodiments, these components of the computing device 1100 may be collectively referred to as computing resources (e.g., resources that are used to carry out execution of instructions and include the processors (one or more processors 1102), storage (one or more memory devices 1104), and I/O (network interface devices 1106, one or more display interfaces 1108, and one or more user input adapters 1110). In some instances, the term processing resources may be used interchangeably with the term computing resources. In some embodiments, multiple instances of computing device 1100 may arranged into a distributed computing system.

In some embodiments, each or any of the processors 1102 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors 1102 uses an instruction set architecture such as x86 or Advanced RISC Machine (ARM).

In some embodiments, each or any of the memory devices 1104 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 1102). Memory devices 1104 are examples of non-transitory computer-readable storage media.

In some embodiments, each or any of the network interface devices 1106 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), LTE Pro, Fifth Generation New Radio (5G NR) and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In some embodiments, data is communicated over an electronic data network. An electronic data network includes implementations where data is communicated from one computer process space to computer process space and thus may include, for example, inter-process communication, pipes, sockets, and communication that occurs via direct cable, cross-connect cables, fiber channel, wired and wireless networks, and the like. In certain examples, network interface devices 1106 may include ports or other connections that enable such connections to be made and communicate data electronically among the various components of a distributed computing system.

In some embodiments, each or any of the display interfaces 1108 is or includes one or more circuits that receive data from the processors 1102, generate (e.g., via a discrete GPU, an integrated GPU, a CPU executing graphical processing, or the like) corresponding image data based on the received data, and/or output (e.g., a High-Definition Multimedia Interface (HDMI), a DisplayPort Interface, a Video Graphics Array (VGA) interface, a Digital Video Interface (DVI), or the like), the generated image data to the display device 1112, which displays the image data. Alternatively, or additionally, in some embodiments, each or any of the display interfaces 1108 is or includes, for example, a video card, video adapter, or graphics processing unit (GPU).

In some embodiments, each or any of the user input adapters 1110 is or includes one or more circuits that receive and process user input data from one or more user input devices (not shown in FIG. 11) that are included in, attached to, or otherwise in communication with the computing device 1100, and that output data based on the received input data to the processors 1102. Alternatively, or additionally, in some embodiments each or any of the user input adapters 1110 is or includes, for example, a PS/2 interface, a USB interface, a touchscreen controller, or the like; and/or the user input adapters 1110 facilitates input from user input devices (not shown in FIG. 11) such as, for example, a keyboard, mouse, trackpad, touchscreen, etc.

In some embodiments, the display device 1112 may be a Liquid Crystal Display (LCD) display, Light Emitting Diode (LED) display, or other type of display device. In embodiments where the display device 1112 is a component of the computing device 1100 (e.g., the computing device and the display device are included in a unified housing), the display device 1112 may be a touchscreen display or non-touchscreen display. In embodiments where the display device 1112 is connected to the computing device 1100 (e.g., is external to the computing device 1100 and communicates with the computing device 1100 via a wire and/or via wireless communication technology), the display device 1112 is, for example, an external monitor, projector, television, display screen, etc.

In various embodiments, the computing device 1100 includes one, or two, or three, four, or more of each or any of the above-mentioned elements (e.g., the processors 1102, memory devices 1104, network interface devices 1106, display interfaces 1108, and user input adapters 1110). Alternatively, or additionally, in some embodiments, the computing device 1100 includes one or more of: a processing system that includes the processors 1102; a memory or storage system that includes the memory devices 1104; and a network interface system that includes the network interface devices 1106. Alternatively, or additionally, in some embodiments, the computing device 1100 includes a system-on-a-chip (SoC) or multiple SoCs, and each or any of the above-mentioned elements (or various combinations or subsets thereof) is included in the single SoC or distributed across the multiple SoCs in various combinations. For example, the single SoC (or the multiple SoCs) may include the processors 1102 and the network interface devices 1106; or the single SoC (or the multiple SoCs) may include the processors 1102, the network interface devices 1106, and the memory devices 1104; and so on. The computing device 1100 may be arranged in some embodiments such that: the processors 1102 include a multi or single-core processor; the network interface devices 1106 include a first network interface device (which implements, for example, WiFi, Bluetooth, NFC, etc.) and a second network interface device that implements one or more cellular communication technologies (e.g., 3G, 4G LTE, CDMA, etc.); the memory devices 1104 include RAM, flash memory, or a hard disk. As another example, the computing device 1100 may be arranged such that: the processors 1102 include two, three, four, five, or more multi-core processors; the network interface devices 1106 include a first network interface device that implements Ethernet and a second network interface device that implements WiFi and/or Bluetooth; and the memory devices 1104 include a RAM and a flash memory or hard disk.

As previously noted, whenever it is described in this document that a software module or software process performs any action, the action is in actuality performed by underlying hardware elements according to the instructions that comprise the software module. Consistent with the foregoing, in various embodiments, each or any combination of the Training computer system 100, feature generation module 106, machine learning training module 108, machine learning training module 112, distributed computer system 800, client system 802, order ports 806, incoming data feed module 809, outgoing data feed module 808, matching engine 810, closing module 812, inference module 852, machine learning subsystem 850, each of which will be referred to individually for clarity as a “component” for the remainder of this paragraph, are implemented using an example of the computing device 1100 of FIG. 11. In such embodiments, the following applies for each component: (a) the elements of the 1100 computing device 1100 shown in FIG. 11 (i.e., the one or more processors 1102, one or more memory devices 1104, one or more network interface devices 1106, one or more display interfaces 1108, and one or more user input adapters 1110), or appropriate combinations or subsets of the foregoing) are configured to, adapted to, and/or programmed to implement each or any combination of the actions, activities, or features described herein as performed by the component and/or by any software modules described herein as included within the component; (b) alternatively or additionally, to the extent it is described herein that one or more software modules exist within the component, in some embodiments, such software modules (as well as any data described herein as handled and/or used by the software modules) are stored in the memory devices 1104 (e.g., in various embodiments, in a volatile memory device such as a RAM or an instruction register and/or in a non-volatile memory device such as a flash memory or hard disk) and all actions described herein as performed by the software modules are performed by the processors 1102 in conjunction with, as appropriate, the other elements in and/or connected to the computing device 1100 (i.e., the network interface devices 1106, display interfaces 1108, user input adapters 1110, and/or display device 1112); (c) alternatively or additionally, to the extent it is described herein that the component processes and/or otherwise handles data, in some embodiments, such data is stored in the memory devices 1104 (e.g., in some embodiments, in a volatile memory device such as a RAM and/or in a non-volatile memory device such as a flash memory or hard disk) and/or is processed/handled by the processors 1102 in conjunction, as appropriate, the other elements in and/or connected to the computing device 1100 (i.e., the network interface devices 1106, display interfaces 1108, user input adapters 1110, and/or display device 1112); (d) alternatively or additionally, in some embodiments, the memory devices 1102 store instructions that, when executed by the processors 1102, cause the processors 1102 to perform, in conjunction with, as appropriate, the other elements in and/or connected to the computing device 1100 (i.e., the memory devices 1104, network interface devices 1106, display interfaces 1108, user input adapters 1110, and/or display device 1112), each or any combination of actions described herein as performed by the component and/or by any software modules described herein as included within the component.

Consistent with the preceding paragraph, as one example, in an embodiment where an instance of the computing device 1100 is used to implement the training computer system 100, the memory devices 1104 could load the input data used in training and the parameters for a neural network (e.g., the weights and the like). Processors 1102 could be used to execute the machine learning processing (e.g., which may involve repeated matrix multiplication and the like) that will gradually cause the weights of the neural network to be adjusted.

The hardware configurations shown in FIG. 11 and described above are provided as examples, and the subject matter described herein may be utilized in conjunction with a variety of different hardware architectures and elements. For example: in many of the Figures in this document, individual functional/action blocks are shown; in various embodiments, the functions of those blocks may be implemented using (a) individual hardware circuits, (b) using an application specific integrated circuit (ASIC) specifically configured to perform the described functions/actions, (c) using one or more digital signal processors (DSPs) specifically configured to perform the described functions/actions, (d) using the hardware configuration described above with reference to FIG. 11, (e) via other hardware arrangements, architectures, and configurations, and/or via combinations of the technology described in (a) through (e).

### Technical Advantages of Described Subject Matter

In certain example embodiments, one or more predictive values are generated based on a current state of a data structure (e.g., which may be a dual-sided data structure). In some examples, the one or more predictive values are used to predict a match value that will be selected or determined by a process of a computing system that matches received data transaction requests (which are included into the data structure) at a future point in time. The predictive values are generated using trained neural networks (which have been trained on prior instances of the data structure in which match values where determined). The approach of using a trained neural network(s) in this manner provides for a technical improvement where the results of the predictive values are more predictive of the future/final determined value(s) than prior approaches. In some instances, the predictive value is more stable (e.g., does not change as much from one prediction to another); more predictive (e.g., a better indicator of the final value throughout the time period in which data transaction requests are accepted); and/or more consistent (e.g., the results of using the training models described herein hold for the vast majority use cases). Further, in certain examples, confidence bounds are also provided in addition to a predictive value. This additional data advantageously allows for better/more stable predictive processing in certain examples.

In certain examples, a neural network is trained to generate an embedding of a state of a data structure (e.g., the dual-sided data structure that is discussed herein). In order to facilitate an understanding of the data set, auxiliary labels may be used. In some examples, the assignment of such labels can be based on characteristics in the data, such as how far the current equilibrium value of the current state of the data structure is from a value that was calculated for this instance of training data. This approach of using automatically assigned labels advantageously facilitates the process of training the neural network as the labels do not need to be manually assigned.

In certain examples, the embedding that is generated is used to represent the state of the data structure within an E-dimensional space. Due to the size of the embedding (e.g., 100s of dimensions) it is at least impractical to process such data in a manual setting. Accordingly, one technical improvement provided by the techniques herein is the use of a neural network to generate an embedding when it would be impractical (or impossible) to generate mentally or manually. Moreover, the total number of weights in the neural network that is used to generate an embedding may be thousands (e.g., 10,000), millions, or larger. The approach of using an embedding to represent a dual-sided data structure (e.g., an order book) is a technical improvement over prior approaches as the number of dimensions represented within the embedding allows for greater fidelity in providing an understanding to machine learning processing regarding the state of the dual sided data structure.

In certain examples, the embeddings that are generated may be used to train multiple additional models in connection with domain specific tasks. The tasks can include generating predictive values that are a function of a current state of the data structure (which is evolving over time)—as represented in the embedding. This technique of using the embeddings to train multiple additional models is a technical improvement over prior approaches as the way in which the embeddings are generated provides are more machine understandable form of the state of the dual-sided structure. It thereby allows more machine learned models to be generated for additional specific tasks. More specifically, the training time for such tasks may be relatively decreased with an approach that uses embeddings as opposed to one that does not.

In certain examples, the preparation of the training dataset for training the embedding model includes transforming an arbitrary sized data set into a fixed sized data set. This advantageously provides training data that is of fixed sized and more easily used in the process for training a neural network. The transformation to a fixed sized input data structure is facilitated in some examples by defining percentage-based windows in which the values from multiple different rows of the arbitrarily sized dataset are combined. This approach allows information represented in the data that has been compressed into a single row to be retained (e.g., at least partly) for the training of the neural network.

### Selected Terminology

The elements described in this document include actions, features, components, items, attributes, and other terms. Whenever it is described in this document that a given element is present in “some embodiments,” “various embodiments,” “certain embodiments,” “certain example embodiments, “some example embodiments,” “an exemplary embodiment,” “an example,” “an instance,” “an example instance,” or whenever any other similar language is used, it should be understood that the given element is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments.

Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an”, and “the” should be read as meaning “at least one,” “one or more,” or the like; the term “example”, which may be used interchangeably with the term embodiment, is used to provide examples of the subject matter under discussion, not an exhaustive or limiting list thereof; the terms “comprise” and “include” (and other conjugations and other variations thereof) specify the presence of the associated listed elements but do not preclude the presence or addition of one or more other elements; and if an element is described as “optional,” such description should not be understood to indicate that other elements, not so described, are required.

As used herein, the term “non-transitory computer-readable storage medium” includes a register, a cache memory, a ROM, a semiconductor memory device (such as D-RAM, S-RAM, or other RAM), a magnetic medium such as a flash memory, a hard disk, a magneto-optical medium, an optical medium such as a CD-ROM, a DVD, or Blu-Ray Disc, or other types of volatile or non-volatile storage devices for non-transitory electronic data storage. The term “non-transitory computer-readable storage medium” does not include a transitory, propagating electromagnetic signal.

The claims are not intended to invoke means-plus-function construction/interpretation unless they expressly use the phrase “means for” or “step for.” Claim elements intended to be construed/interpreted as means-plus-function language, if any, will expressly manifest that intention by reciting the phrase “means for” or “step for”; the foregoing applies to claim elements in all types of claims (method claims, apparatus claims, or claims of other types) and, for the avoidance of doubt, also applies to claim elements that are nested within method claims. Consistent with the preceding sentence, no claim element (in any claim of any type) should be construed/interpreted using means plus function construction/interpretation unless the claim element is expressly recited using the phrase “means for” or “step for.”

Whenever it is stated herein that a hardware element (e.g., a processor, a network interface, a display interface, a user input adapter, a memory device, or other hardware element), or combination of hardware elements, is “configured to” perform some action, it should be understood that such language specifies a physical state of configuration of the hardware element(s) and not mere intended use or capability of the hardware element(s). The physical state of configuration of the hardware elements(s) fundamentally ties the action(s) recited following the “configured to” phrase to the physical characteristics of the hardware element(s) recited before the “configured to” phrase. In some embodiments, the physical state of configuration of the hardware elements may be realized as an application specific integrated circuit (ASIC) that includes one or more electronic circuits arranged to perform the action, or a field programmable gate array (FPGA) that includes programmable electronic logic circuits that are arranged in series or parallel to perform the action in accordance with one or more instructions (e.g., via a configuration file for the FPGA). In some embodiments, the physical state of configuration of the hardware element may be specified through storing (e.g., in a memory device) program code (e.g., instructions in the form of firmware, software, etc.) that, when executed by a hardware processor, causes the hardware elements (e.g., by configuration of registers, memory, etc.) to perform the actions in accordance with the program code.

A hardware element (or elements) can therefore be understood to be configured to perform an action even when the specified hardware element(s) is/are not currently performing the action or is not operational (e.g., is not on, powered, being used, or the like). Consistent with the preceding, the phrase “configured to” in claims should not be construed/interpreted, in any claim type (method claims, apparatus claims, or claims of other types), as being a means plus function; this includes claim elements (such as hardware elements) that are nested in method claims.

### Additional Applications of Described Subject Matter

Although examples are provided herein with respect to the trading of equities (i.e., equity securities/stock), the technology described herein may also be used, mutatis mutandis, with any type of asset, including but not limited to other types of financial instruments (e.g., bonds, options, futures), currencies, cryptocurrencies, and/or non-financial assets. Further, although examples are provided herein with respect to electronic trading platforms, the technology described herein may also be used, mutatis mutandis, with other types of distributed computing systems, including but not limited to telecommunication networks, payment processing systems, industrial control systems, parallel scientific computation systems, smart contract systems, transaction processing systems, traffic management systems, weather systems, distributed databases, and/or other types of distributed systems that process large amounts of data for which the state of the system may be transformed into an embedding that is then used for additional machine learning tasks.

Although process steps, algorithms, or the like, including without limitation with reference to FIGS. 2 and 9, may be described or claimed in a particular sequential order, such processes may be configured to work in different orders. In other words, any sequence or order of steps that may be explicitly described or claimed in this document does not necessarily indicate a requirement that the steps be performed in that order; rather, the steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, element, component, or step in this document is intended to be dedicated to the public.

1. A computer system for training a plurality of task models by training and embedding model, the computer system comprising:
non-transitory storage configured to store a first training dataset;
at least one hardware processor configured to execute instructions that are stored in the non-transitory storage to perform operations comprising:
preparing the first training dataset that is used to train a first neural network, wherein the preparing the first training dataset includes:
(a) generating, by traversing a plurality of data transaction messages, a first data structure that corresponds to a state of a dual-sided data structure at a point in time;
(b) transforming the first data structure into a fixed sized data structure;
(c) automatically assigning, based on one or more data values of the fixed sized data structure, one of a plurality of class labels to the fixed sized data structure; and
(d) generating a plurality of training samples of the first training dataset, wherein each one of the plurality of training samples includes: 1) as an anchor member, a fixed sized data structure that has been assigned a first class of the plurality class labels, 2) as a positive member, another fixed sized data structure that has been assigned the first class, and 3) as a negative member, another fixed sized data structure that has been assigned another class that is different from the first class;
training the first neural network by using the first training dataset, the first neural network trained to generate an embedding of a given input data structure;
preparing a second training dataset that includes embeddings generated by using the trained first neural network;
training a first task model using the second training dataset; and
training a second task model using the second training dataset, wherein the first task model is trained for a different task than the second task model.

2. The computer system of claim 1, wherein the first task model is trained to output one predictive value per input data structure and the second task model is trained to output two predictive values per the input.

3. The computer system of claim 2, wherein the two predictive values are upper and lower bound percent-based confidence values.

4. The computer system of claim 1, wherein the first neural network is trained using N-paired loss based on the plurality of training samples.

5. The computer system of claim 1, wherein the size of the trained first neural network includes at least 10000 weights.

6. The computer system of claim 1, wherein the operations further comprise:
as part of preparing the first training dataset, generating a plurality of statistical values that are each based on values of the first data structure that corresponds to the state of a dual-sided data structure at the point in time.

7. The computer system of claim 1, wherein the operations further comprise:
as part of preparing the first training dataset, combining data from multiple rows into data that is contained within a single row of the fixed sized data structure.

8. The computer system of claim 7, wherein the first data structure includes a plurality of match value levels, with each of the plurality of match value levels corresponding to at least one data transaction request that would match at the corresponding match value level,
wherein the combining of first data includes combining data from different match levels into one level of the fixed sized data structure.

9. The computer system of claim 8, wherein the operations further comprise:
calculating an equilibrium match value based on the data included in the first data structure,
wherein how the first data is combined is based on the calculated equilibrium match value.

10. The computer system of claim 9, wherein each of the plurality of match value levels are associated with a plurality of predefined windows, wherein each of the plurality of predefined windows are a set percentage away from the equilibrium match value.

11. The computer system of claim 10, wherein a percentage amount of coverage for multiple ones of the plurality of predefined windows is different.

12. The computer system of claim 1, wherein the second training dataset is based on embeddings generated from the first training set using the trained first neural network.

13. The computer system of claim 1, wherein each of the plurality of class labels is associated with a corresponding anchor member within the plurality of training samples.

14. The computer system of claim 1, wherein the operations further include:
as part of preparing the first training dataset, calculating an equilibrium value that is based on data within the first data structure, wherein the plurality of class labels are set based on the calculated equilibrium value.

15. A system comprising:
the computer system of claim 1; and
a distributed computer system configured to execute the trained neural network, the first task model, and the second task model based on a current state of a dual-sided data structure that is being modified based on acceptance of newly received data transaction requests to the distributed computer system, wherein a generated view of the dual-sided data structure is used as input to the trained neural network to generate an embedding, wherein the embedding is used to perform machine learning inference using the first task model and the second task model to generate at least two predicate values.

16. The system of claim 15, wherein the operations further comprise:
training a third model using a third training dataset, wherein the third model is trained without relying upon the first trained first neural network,
wherein the distributed computer system configured to is further configured to execute the third model and perform machine learning inference based on the generated view of the dual-sided data structure without relying on the generated embedding.

17. A method of training a plurality of task models by training an embedding model, the method comprising:
preparing a first training dataset that is used to train a first neural network, wherein preparation for the first training dataset includes:
(a) generating, by traversing a plurality of data transaction messages, a first data structure that corresponds to a state of a dual-sided data structure at a point in time;
(b) transforming the first data structure into a fixed sized data structure;
(c) automatically assigning, based on one or more data values of the fixed sized data structure, one of a plurality of class labels to the fixed sized data structure; and
(d) generating a plurality of training samples of the first training dataset, wherein each one of the plurality of training samples includes: 1) as an anchor member, a fixed sized data structure that has been assigned a first class of the plurality class labels, 2) as a positive member, another fixed sized data structure that has been assigned the first class, and 3) as a negative member, another fixed sized data structure that has been assigned another class that is different from the first class;
training the first neural network by using the first training dataset, the first neural network trained to generate an embedding of a given input data structure;
preparing a second training dataset that includes embeddings generated by using the trained first neural network;
training a first task model using the second training dataset; and
training a second task model using the second training dataset, wherein the first task model is trained for a different task than the second task model.

18. The method of claim 17, further comprising, as part of preparing the first training dataset, combining data from multiple rows into data that is contained within a single row of the fixed sized data structure.

19. A computer system for generating predictions based on a state of a data structure that is being modified, the computer system comprising:
non-transitory storage configured to store a trained neural network, a first task model, and a second task model; and
at least one hardware processor configured to execute instructions that are stored in the non-transitory storage to perform operations comprising:
based on processing of each of a plurality of received data transaction requests messages, modifying a dual-sided data structure over a time period;
(a) generating an input data structure that is based on a state of the dual-sided data structure at a point in time within the time period;
(b) transforming the input data structure into a fixed sized input data structure;
(c) generating, using the trained neural network, an embedding of the fixed sized input data structure;
(d) performing machine learning inference using the generated embedding with the first task model to output a predictive value;
(e) performing machine learning inference using the generated embedding with the second task model to output at least two predictive values; and
transmitting, to third party computer systems, at least one data message that is based on the predictive value and the at least two predictive values.

20. The computer system of claim 19, wherein (a)-(e) is performed at or about once every one second.

21. The computer system of claim 19, wherein the operations further comprise executing a matching engine that matches differently sided data transaction requests to one another.

22. The computer system of claim 19, wherein the operations further comprise:
performing third machine learning inference based on the fixed sized input data structure of (b) with a third model to output at least a third predictive value, wherein the third machine learning inference is performed without relying on first generating an embedding.

23. The computer system of claim 19, wherein transforming the input data structure into the fixed sized input data structure includes combining data from multiple rows of the input data structure into a single row of the fixed sized input data structure.
